(19) United States
(12) Patent Application Publication
(10) Pub. No.: US 2025/0131608 A1
(43) Pub. Date: Apr. 24, 2025

(54) METHOD FOR GENERATING ADAPTIVE CONVERSATION IMAGES THROUGH EMOTION REGULATION AND DEVICE FOR PERFORMING THE SAME METHOD

(71) Applicant: Dong June KIM, Seoul (KR)

(72) Inventor: Dong June KIM, Seoul (KR)

(21) Appl. No.: 18/512,664

(22) Filed: Nov. 17, 2023

(30) Foreign Application Priority Data
Oct. 23, 2023 (KR) 10-2023-0141712

(51) Int. Cl. G06T 11/00; G06F 40/30; G06V 10/764; G06V 10/774; G06V 10/82; G06V 10/94; G06V 40/16

(52) U.S. Cl. CPC G06T 11/00; G06F 40/30; G06V 10/764; G06V 10/774; G06V 10/82; G06V 10/945; G06V 40/174

(57) ABSTRACT

The present disclosure relates to a method for generating conversation images through emotion recognition using deep learning. The method includes: a step of recognizing an object in an input image; a step of extracting a text by comparing emotion combination information for each object of the recognized object with emotion combination information in a unit of a sentence in a matching candidate text; a step of generating a conversation image including the emotion combination information by mapping at least a part of image of the object with the extracted text; and a step of receiving emotion combination change information, wherein in the step of extracting the text, the text is re-extracted by comparing the changed combination change information with the emotion combination information in the unit of a sentence. The present disclosure may allow a user to change image emotion himself/herself.

### CROSS-REFERENCE TO RELATED APPLICATION(S)

This application claims benefit of priority to Korean Patent Application No. 10-2023-0141712 filed on Oct. 23, 2023, in the Korean Intellectual Property Office, the disclosure of which is incorporated herein by reference in its entirety.

### BACKGROUND

### 1. Field

The present disclosure relates to a method for generating conversation images through emotion recognition using deep learning.

### 2. Description of Related Art

In accordance with the developments of a smartphone and mobile communication technology, a user may now simply and conveniently use a function used to be performed offline anytime and anywhere, and communicate with another user through various channels anytime and anywhere.

The user may actively share information such as recording the user's own daily lives, sympathizing with or re-sharing a feed related to another user's daily lives, or the like through a social network service, and may easily share not only a text but also a photo, a video, or the like.

Furthermore, the development of artificial intelligence technology has made it possible to provide the user with a wider variety of services as the smartphone becomes popular. In recent years, the artificial intelligence technology has been used not only for a simple functional function but also as a factor which may stimulate user interest by recognizing the user's face and generating virtual makeup directly on the face, or applying various changes to the face.

This developed social network has recently been used as an important marketing channel based on its influence, and encourages the user's participation and produces more interesting content through the participation rather than providing direct advertising information. As a result, an effort is being made to provide a more active advertising effect.

### SUMMARY

An object of the present disclosure is to extract emotion information matching emotion based on an image while using a mobile-based emotion recognition model.

In more detail, an object of the present disclosure is to classify text emotion through deep learning-based natural language processing, and generate a conversation image based on a text matching image emotion.

Another object of the present disclosure is to generate more diverse conversation images by allowing a user to change the image emotion himself/herself.

Still another object of the present disclosure is to provide a method for generating a conversation image that reflects a feature of the location or background of a personalized image itself, and has a minimized personal information usage.

According to an embodiment of the present disclosure, provided is a method for generating conversation images, the method including: a step of recognizing an object in an input image; a step of extracting a text by comparing emotion combination information for each object of the recognized object with emotion combination information in a unit of a sentence in a matching candidate text; a step of generating a conversation image including the emotion combination information by mapping at least a part of image of the object with the extracted text; and a step of receiving emotion combination change information, wherein in the step of extracting the text, the text is re-extracted by comparing the combination change information with the emotion combination information in the unit of a sentence.

The step of generating the conversation image may include a step of regenerating at least a portion of a virtual facial image of the object based on the emotion combination change information, and a step of regenerating image including the changed emotion the conversation combination change information by mapping the regenerated virtual facial image with the re-extracted text.

The step of generating the conversation image may include a step of regenerating the virtual facial image in which the conversation image may be regenerated by using a neural network symmetrical to a neural network that extracts the emotion combination information for each object of the recognized object.

The neural network may perform reinforcement training by using a difference between emotion output by receiving the partial image and the virtual facial image.

The neural network may perform the reinforcement training by compensating for a difference between ranking of the emotion.

As set forth above, the present disclosure may use the emotion recognition model to match the image emotion with the text emotion, thus allowing the user to generate the various conversation images. In this way, the user may select or generate the conversation image matching his/her emotion state or intention.

The present disclosure may use the deep learning-based natural language processing technology to classify the text emotion, and match the same with the image emotion, thus generating the conversation image connected to the emotion. In this way, the user may easily find the text matching the emotion inherent in the image.

In addition, the present disclosure may allow the user to change the image emotion himself/herself. In this way, the user may generate a conversation image in which various emotion are expressed based on the user's situation or need.

In addition, the present disclosure may use the emotion recognition and matching technology, the function to change the user's emotion, and the harmonious approach of the personalization and the personal information protection. Therefore, the user may generate and utilize the richer and more various conversation images, which may improve the quality of communication and enhance the individual expressiveness.

### BRIEF DESCRIPTION OF DRAWINGS

FIG. 1 is a schematic view showing a structure of a conversation image generation system according to an embodiment of the present disclosure.

FIG. 2 is a flowchart showing a method for generating conversation images according to another embodiment of the present disclosure.

FIG. 3 is an exemplary view showing a configuration of an image emotion classification neural network that performs the method for generating conversation images according to another embodiment of the present disclosure.

FIG. 4 is an exemplary view showing a configuration of a text emotion classification neural network that performs the method for generating conversation images according to another embodiment of the present disclosure.

FIG. 5 is an exemplary view showing a matching example through a result from a neural network model according to another embodiment of the present disclosure.

FIG. 6 is an exemplary view showing a conversation image generated according to another embodiment of the present disclosure.

FIG. 7 is an exemplary view showing a conversation image interface generated according to another embodiment of the present disclosure.

FIG. 8 is an exemplary view showing a detailed example of the conversation image interface generated according to another embodiment of the present disclosure.

FIG. 9 is an exemplary view showing a facial image generated according to another embodiment of the present disclosure.

FIG. 10 is an exemplary view showing a training process of the neural network according to another example of the present disclosure.

FIG. 11 is an exemplary view showing an additional service of the conversation image interface generated according to another embodiment of the present disclosure.

FIG. 12 is an exemplary view showing a detailed example of an interface for providing an original text generated according to another embodiment of the present disclosure.

FIG. 13 is an exemplary view showing an example of providing an original text generated according to another embodiment of the present disclosure.

FIG. 14 is an exemplary view showing a detailed example of providing the original text generated according to another embodiment of the present disclosure.

FIG. 15 is an exemplary view showing a server implemented in the form of a computing device according to still another embodiment of the present disclosure.

### DETAILED DESCRIPTION

The following description illustrates only a principle of the present disclosure. Therefore, those skilled in the art may implement the principle of the present disclosure and invent various devices included in the spirit and scope of the present disclosure although not clearly described or shown in the specification. In addition, it is to be understood that all conditional terms and embodiments mentioned in the specification are obviously intended only to allow those skilled in the art to understand a concept of the present disclosure in principle, and the present disclosure is not limited to the embodiments and states particularly mentioned as such.

The above-mentioned objects, features and advantages are to be more obvious from the following detailed description provided in relation to the accompanying drawings. Therefore, those skilled in the art to which the present disclosure pertains may easily practice the spirit of the present disclosure.

Further, in describing the present disclosure, omitted is a detailed description of a case where it is determined that a detailed description of well-known technology associated with the present disclosure may unnecessarily make the gist of the present disclosure unclear. Hereinafter, the embodiments of the present disclosure are described in detail with reference to the accompanying drawings.

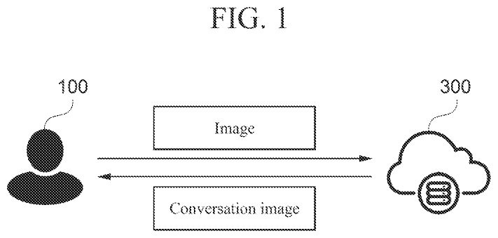

FIG. 1 is a view showing a configuration of a system that performs a method for generating conversation images according to an embodiment of the present disclosure.

Referring to FIG. 1, a user terminal 100 may receive an input image to extract emotion information from the image by using a deep learning model and generate the conversation image.

Next, the user terminal 100 may transmit image information to a server 300 in order to generate the conversation image. In addition to the emotion information, the image information may include information related to image-capturing location or location tag information related to image-capturing time or location.

The server 300 may recognize emotion through a facial expression of an object in the input image, preferably, a human. The server 300 may extract a matching text from the received image information and transmit the matching text back to the user terminal 100.

The user terminal 100 may reconfigure the conversation image by using the received matching text and the image, and provide the user with the same.

In detail, the server 300 may recognize a human facial expression through a trained neural network 50, and output an emotion classification result.

Furthermore, in this embodiment, the server 300 may collect text information in advance, classify the emotion information, and generate a database (DB) in order to generate the conversation image.

The server 300 according to this embodiment, which collects a text such as a novel or a scenario, may classify the text for each emotion in the text DB.

In detail, the server 300 may classify the emotion included in a sentence in a unit of the sentence in the text, and preferably use the neural network to classify the emotion based on the same classification as the emotion classification in the image described above.

In addition, the neural network that classifies the texts in this embodiment may be trained to reflect a classification result of a previous sentence to a current sentence classification result by a circular neural network structure, and may further collect information on the location or background in the text together with the classification result to store the same.

In addition, it is also possible for an author of the novel or the scenario to directly store the text labeled in the sentence unit in the DB without the classification of the neural network.

The server may primarily extract a matching candidate text from the DB above.

A matching candidate text extractor may extract the matching candidate text to be used for generating the conversation image from all the texts based on location information such as a global positioning system (GPS), a location tag, and a background object in the image.

In detail, the matching candidate text may be extracted in units of various novels or scenarios, or in more detail, in a unit of a novel chapter or a scenario scene.

Next, a matching text extractor may extract a sentence specifically matching image emotion from the extracted matching candidate text.

A sentence finally extracted through the above process may be transmitted back to the user terminal 100, and the user terminal may thus use the same to generate the conversation image.

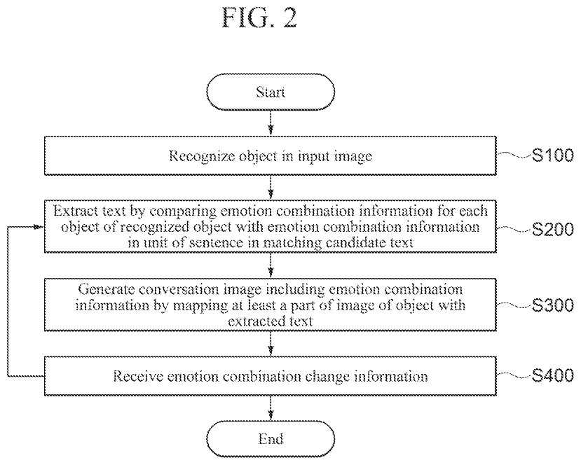

Hereinafter, referring to FIG. 2, the description describes a method for generating conversation images according to another embodiment of the present disclosure that is performed by the server 300.

An object in an input image may be recognized (S100).

In detail, in this embodiment, a human in an image may be recognized, and in particular, a face expressing human emotion may be detected in the image.

Next, emotion for each object of the recognized object may be recognized through the trained neural network. The emotion of the detected face may be classified. In detail, the neural network may be trained to detect the face in the image and classify the emotion by the shape or color of the eyes, nose, mouth, or the like in the face.

In this embodiment, the emotion may be classified into seven types: joy, sadness, surprise, no expression, fear, disgust, and anger, and a specific classification result may be output by the neural network as a probability value of each classification.

Next, a text may be extracted by comparing emotion combination information for each object of the recognized object with the emotion combination information in a unit of a sentence in a matching candidate text (S200).

That is, in this embodiment, under an assumption that at least two humans are detected from the image, each emotion state of the detected humans may be generated as the combination information. In a step of recognizing the emotion, information on the emotion may be sequentially extracted based on locations of the humans in the image.

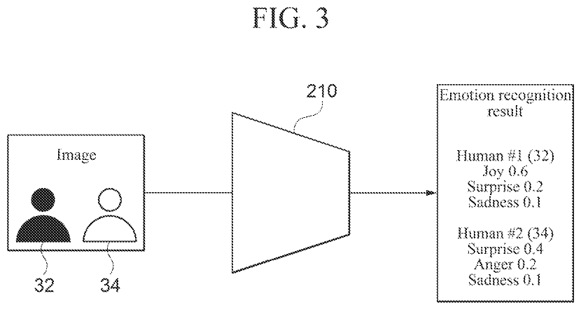

Referring to FIG. 3, in this embodiment, a neural network 210 may recognize the object in the image, classify the same in a predetermined order, and recognize the emotion of the object.

To describe a process of recognizing the emotion in the image by the neural network 210 in this embodiment with reference to FIG. 3, the neural network 210 may classify the objects in an order based on their relative locations, for example, with the top left as the top priority, and generate the emotion combination information in the classified order.

In this embodiment, the neural network 210 may be a model that classifies the emotion into the seven types, and implemented as a convolutional neural network (CNN). The CNN may be particularly effective in image processing to thus be used to determine the emotion in a face image. The human face image may be input to an input layer, and this image may be expressed as a matrix of pixel values. Next, a convolutional layer may be used to extract a feature of the image. The convolutional layer may extract information such as a pattern, a texture, a color, or the like from the image by using a plurality of filters.

An activation function may introduce nonlinearity to allow the model to learn a complex pattern. For example, the model may use a rectified linear unit (ReLU) function. Next, a pooling layer may reduce a dimension of the image and reinforce its feature, and a fully connected layer may calculate a probability of each emotion class by using the extracted feature. For example, the fully connected layer may use a softmax function as the activation function to acquire each probability of seven emotion classes.

A (final) output layer may output the probability of each emotion class, and a class having the highest probability may be predicted emotion.

The neural network is required to be trained on a large facial image dataset, and this dataset is required to include an emotion label such as joy, sadness, surprise, no expression, fear, disgust, anger, or the like. The neural network trained in this way may predict emotion in a new face image.

Through the neural network, emotion of a human #1 (32) may be classified as joy with the highest probability, and emotion of a human #2 (34) may be classified as surprise with the highest probability. As a result, the emotion combination information may be determined in a joy-surprise order.

Next, the server may extract the text by performing the comparison with the emotion combination information in the unit of a sentence in the matching candidate text.

As an additional example, only the emotion combination information may be transmitted to the server 300 by using the trained neural network in the user terminal 100. In this case, instead of directly transmitting the image to the server 300, only the emotion combination information may be transmitted to the server 300, thereby minimizing a risk of personal information usage or leakage.

The server 300 may configure a database in advance to extract a matching text and provide the user terminal 100 with the same as described above.

In order to configure the database, the emotion in the sentence of the text may be classified using the trained neural network.

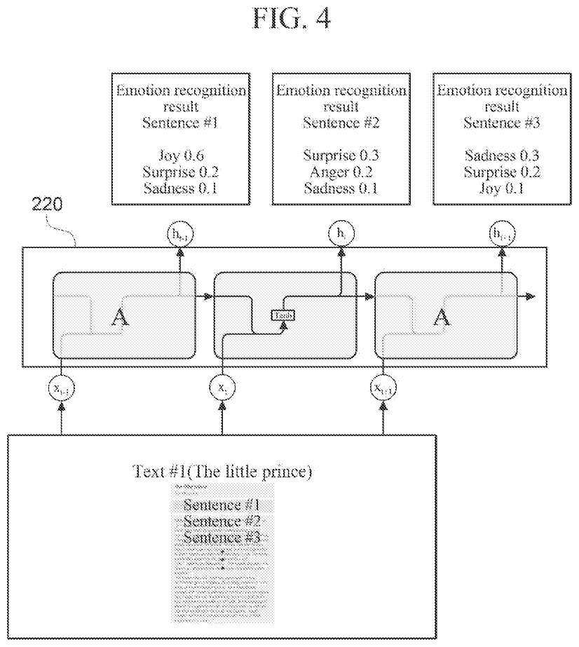

To describe this configuration in more detail with reference to FIG. 4, a second neural network 220 according to this embodiment may have a circular neural network structure to reflect a result of a previous sentence based on a weight and use the same to classify emotion of a current sentence and output the classification result of the emotion for each sentence in the text.

A second neural network 220 may be a long short-term memory (LSTM) model, which is a type of a recurrent neural network (RNN), and may be trained on sequence data. The second neural network 220 may identify a context by combining information in a previous step with an input in a current step, and determine the emotion in each sentence of the novel based thereon.

The second neural network 220 may be the input layer, and use each sentence of the novel as an input to the model through tokenization and embedding processes. Here, the tokenization process may be a process of separating the sentence into tokens such as words, and the embedding process may be a process of converting each token into a high-dimensional vector.

A long short-term memory (LSTM) layer may use the information in the previous step to determine a context of a sentence in the current step. The LSTM layer may be trained on long-term dependency by internally maintaining a cell state and a hidden state.

The output layer may classify the emotion in each sentence based on the output of the LSTM layer, and output the probability of each emotion class by using the softmax activation function.

The second neural network 220 may determine the emotion in each sentence of the novel by considering continuity and context between the sentences. A large amount of labeled text data may be required to train the second neural network 220, and the model may be trained on a pattern between the sentences and the emotion corresponding thereto by using this dataset.

The trained second neural network 220 may predict the emotion in each sentence of a new novel text.

For example, in this embodiment, the neural network may output a classification result of a sentence #1 as joy, a classification result of a sentence #2 as surprise, and a classification result of a sentence #3 as sadness, in a literature (e.g., “The Little Prince”) referred to as a text #1.

The server 300 may extract the matching text from the DB generated based on the above classification result. Furthermore, in this embodiment, the server 300 may primarily select a candidate group from which the matching text is to be extracted.

To this end, the server 300 may use the location information of the input image.

In detail, the matching text may be extracted from the matching candidate text extracted using the location information in the image or background element information that defines the location in the image of the recognized object.

Therefore, the server 300 may first extract sentences in the text that have similar locations, thus increasing a matching level between the image and the text, and reducing resources required to search for the emotion combination information.

Next, the server 300 may extract a text having the emotion combination information in the unit of a sentence whose order matches sequential information of the emotion recognized from the image.

That is, the above-described image the emotion combination information may be joy-surprise. Accordingly, when the text #1 is included in the matching candidate text, the sentences #1 and #2 in the matching candidate text may be extracted as the matching text.

Therefore, the user terminal 100 may generate the conversation image by using the sentences #1 and #2. In addition, in this embodiment, it is also possible to use more complex emotion information in generating the conversation image.

That is, it is also possible to extract the matching text by using each probability of an emotion classification result, rather than only using an emotion classification result with the highest priority.

Therefore, the emotion combination information recognized from the image may include a plurality of combinations of first priority emotion and second priority emotion for each object. In this case, in a step of receiving the matching text, a text having emotion combination in the unit of a sentence and having an order matching sequential information of the first and second priority emotion may be extracted.

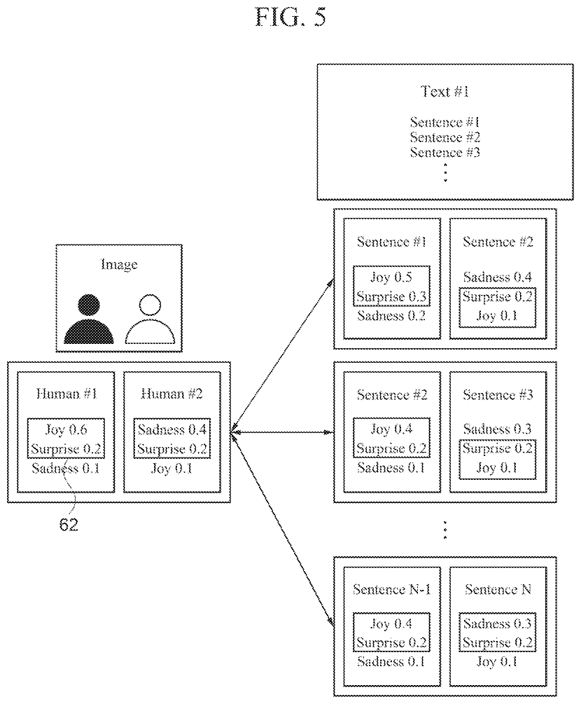

Referring to FIG. 5, it is also possible to extract, as the matching text, a combination of sentences having the highest matching level that is acquired by determining a classification probability of emotion corresponding to the top two ranking among the emotion classification results of the humans #1 and #2, and the matching level of a classification probability value of the emotion corresponding to each sentence. The matching level may be calculated as the sum of the products of the probability values of the emotion matching each other, and a text having the highest value may be extracted as the matching text.

Next, the server 300 may generate the conversation image by mapping the matching text of the extracted emotion combination information with at least a partial image of the object (S300).

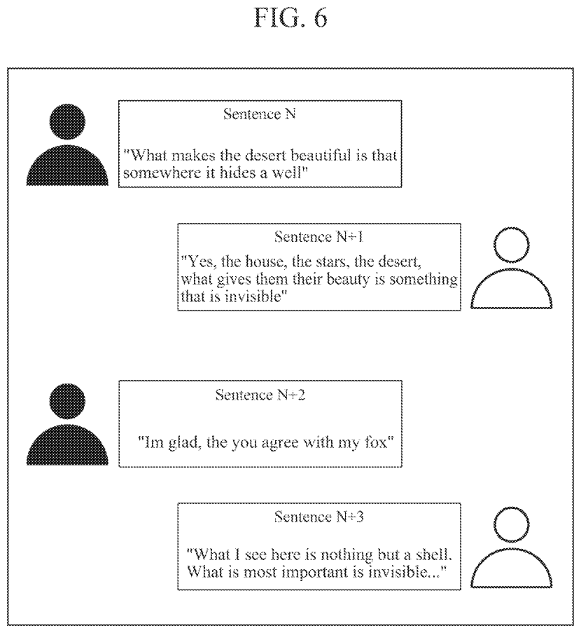

The server 300 may sequentially list the face image of the object and the received matching text to generate the conversation image. For example, referring to FIG. 6, the conversation image may be generated by extracting only the face from the image and sequentially listing a mutual conversation.

Further, in this embodiment, the emotion combination information may be sequentially generated as the user inputs the image continuously. When the recognized objects in the input image are the same as each other, it is also possible to generate a longer conversation image.

Accordingly, the server 300 may receive the matching text extracted using the emotion combination information in the matching candidate text extracted from a previous image.

In addition, when receiving two consecutive images of the user, the server 300 may extract dialogue sentences from the novel “The Little Prince” that match an order of each emotion state to generate the same as the conversation images.

Next, the server 300 may receive emotion combination change information (S400).

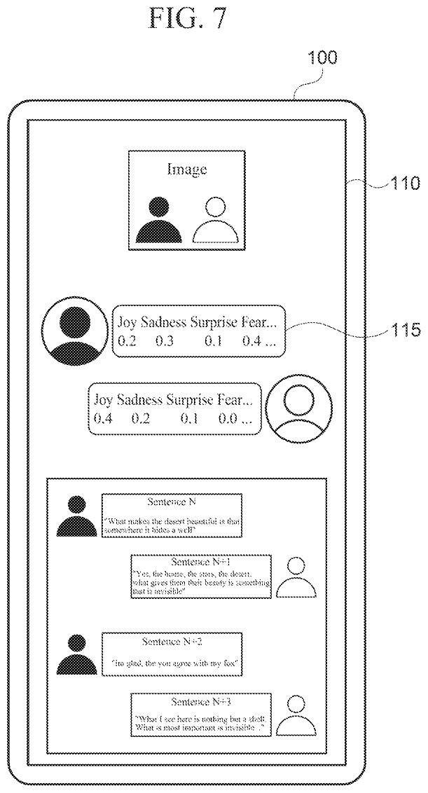

Referring to FIG. 7, the server 300 may provide the user terminal 100 with all of the input image, classification information on the emotion of the recognized object in the image, and the conversation image extracted therefrom.

Next, the user terminal 100 may provide the user with an input interface 115 to enable the user to change the emotion.

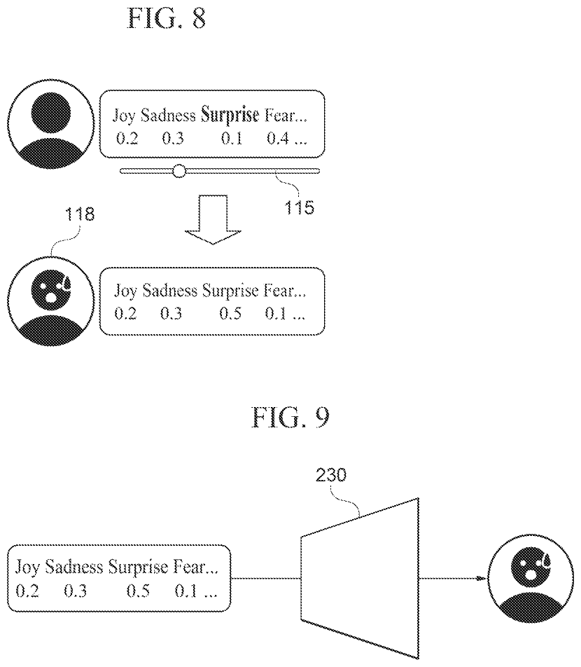

In detail, to describe the interface with reference to FIG. 8, the interface for manually changing the probability of seven emotion classes may be provided to the user in an intuitive and easy-to-use manner.

For example, the interface may be a slider-based interface, that is, provide a slider for each emotion class, and the user may regulate the probability. The user may set the probability at a desired rate by moving each slider, and the sum of all the sliders is regulated to be 100%.

Alternatively, the interface may provide a text box where the user may directly input the probability value of each emotion class as an input box. Here, a validation test may be performed to ensure that the sum of the input values is not more than 100%.

Alternatively, the interface may use a pie chart to visually display the probability of each class, and the user may drag each section of the chart to regulate its size and thus change the probability.

Alternatively, the interface may use a toggle switch disposed on each emotion class to activate/deactivate each emotion to be used to set the probability class through the toggle switch and rate regulation. The probability may be set by providing the slider or the input box for regulating a rate of the activated class.

Furthermore, the interface may provide several probability distribution presets that the user may frequently use, thus enabling the user to select one of these presets and make its detailed regulation as needed.

The interface may be designed to be user-friendly for the user to easily regulate the probability of the emotion class based on his or her needs and minimize an input error, through this interface.

Further, the server 300 may regenerate at least a portion of a virtual facial image of the object based on the changed emotion combination change information. The server 300 may preferably regenerate the human facial expression.

To regenerate the human facial expression, the server 300 may change the facial expression by using a layer that performs deconvolution of a third neural network 230 designed to be symmetrical to the convolutional layer that extracts the above-described emotion.

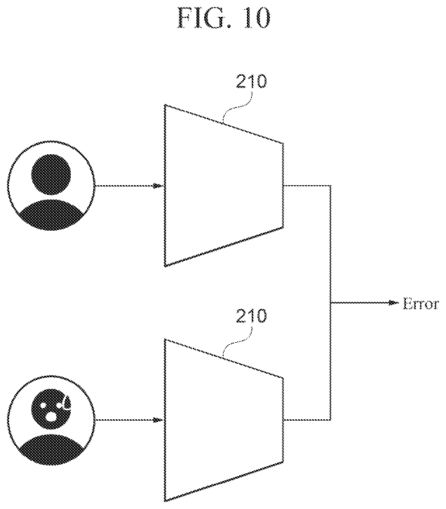

Referring to FIG. 9, the third neural network 230 may use emotion probability distribution as an input to the deconvolutional layer. The deconvolutional layer may use this input to generate a color value of each pixel while restoring a size of an original image. The third neural network 230 may be trained in a training process to minimize a difference between the original image and the generated image.

To describe the training process with reference to FIG. 10, the server 300 may perform training of the first neural network 210 by receiving an error between two emotion classifications, that is, an image used for initial emotion classification by using the first neural network 210 described above (preferably, a first facial image in the conversation image including only a face of the object) and a second facial image regenerated by the third neural network 230, and configure a training pipeline for reducing a difference in the image generated by the third neural network 230 by receiving a performed training result.

Therefore, performance of the third neural network 230 may be improved based on performance improvement of the first neural network 210.

As described above, the second facial image may be generated as the human manually changes the emotion combination of the first facial image. Therefore, the first neural network 210 may be trained for a difference between a classification result of the second facial image and a classification result of the first facial image to be close to the change in the emotion combination.

Alternatively, the first neural network 210 may perform reinforcement training to increase the rank of target emotion through the change among the ranking based on the difference between the classification results of the first facial image and the second facial image for the target emotion having the highest probability change.

The server 300 may then re-extract the text by comparing the changed combination change information with the emotion combination information in the unit of a sentence, and regenerate the conversation image including the changed emotion combination change information by mapping the regenerated virtual facial image with the re-extracted text.

Further, in this embodiment, the server 300 may additionally provide an original text including texts used for generating the conversation image by using a conversation image interface.

The server 300 may provide an additional menu to draw an interest of the service user that is aroused through some conversations displayed through the conversation image interface to the original text.

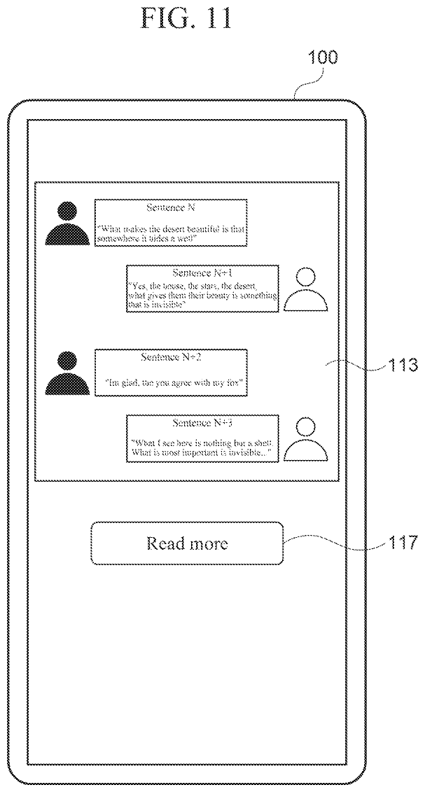

FIG. 11 is an exemplary view showing the additional service of the conversation image interface generated according to another embodiment of the present disclosure.

Referring to FIG. 11, the server 300 may further provide a menu 117 inducing the user to read more about the novel “The Little Prince”, for example, as the original text following a menu 113 generated as the conversation image by extracting dialogue sentences from the novel “The Little Prince” shown in FIG. 7.

In this embodiment, the original text may be provided as a set of cards including the images. Hereinafter, the description describes an example of providing the original text in more detail with reference to the drawings.

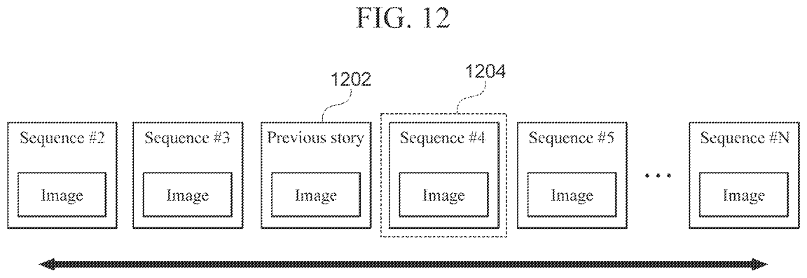

FIG. 12 is an exemplary view showing a detailed example of an interface for providing an original text generated according to another embodiment of the present disclosure.

Referring to FIG. 12, the server may provide the original text in the form of a card 1204 classified into a plurality of sequences.

The original text may be provided by being classified into cards having N sequences.

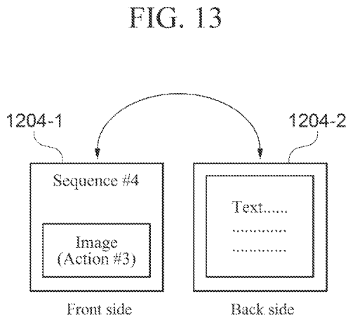

FIG. 13 is an exemplary view showing an example of providing the original text generated according to another embodiment of the present disclosure. Here, with reference to FIG. 13, each card may include an image representing the sequence on its front side 1204-1, and a back side 1204-2 may include the original text corresponding to a representative image, for example, a paragraph from the novel “The Little Prince”.

In addition, the server 300 in this embodiment may provide a previous story summarizing stories prior to a card in a sequence selected and confirmed by the user before a current sequence. Here, the previous story may be provided in the form of a temporary card 1202 generated by providing a summary of a determined number of previous sequences for the current sequence.

The user may also search the sequences and check a card in a desired sequence by swiping or scrolling the cards in a listed sequence.

In addition, the sequence may separate a detailed event into an action. For example, about k actions may exist in each sequence. In this case, the actions may be further configured in the interface for providing an original text to enable an additional search for the action in the sequence.

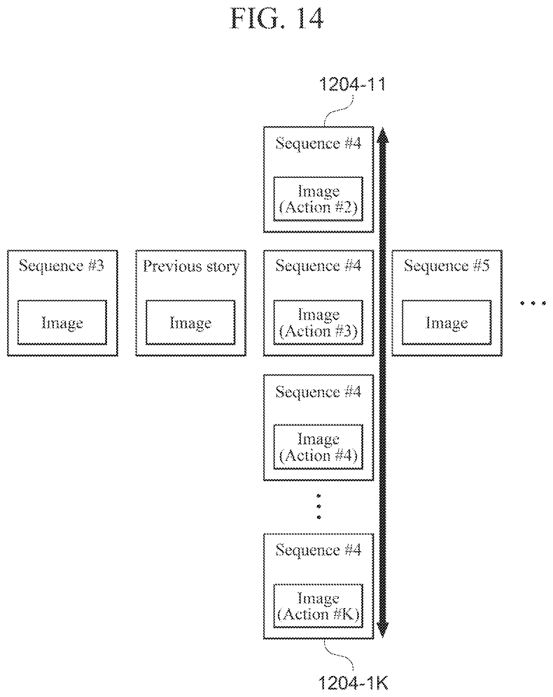

FIG. 14 is an exemplary view showing a detailed example of providing the original text generated according to another embodiment of the present disclosure.

Referring to FIG. 14, the server 300 may provide an interface, which is physically classified from an interface for searching for the above-described sequence and enables search for actions 1204-11 to 1204-1K in the sequence.

Here, the physical classification may refer to providing a search for each action through a scrolling interface perpendicular to a left-right swiping interface, for example, when the left-right swiping interface is provided.

Through the interface for providing an original text described above, the user may check the original text including directly captured images and texts extracted based on the emotion regulation, and receive a recommendation for a reading activity based on the aroused interest when the user is a child or a teenager.

Hereinafter, the description describes detailed hardware implementation of the server 300 according to still another embodiment of the present disclosure.

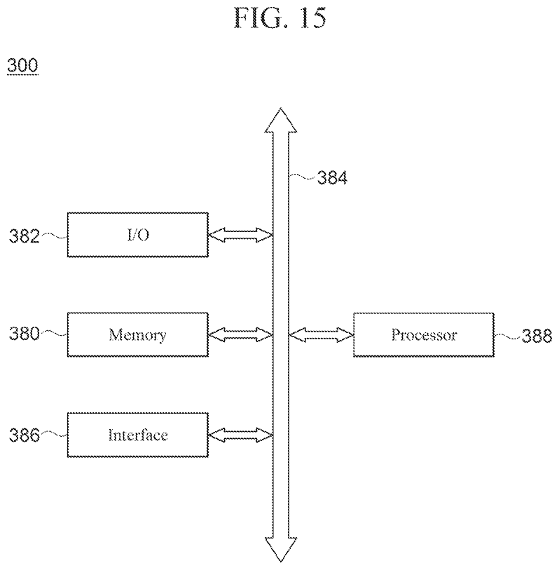

Referring to FIG. 15, in some examples of the present disclosure, the server 300 may be implemented in the form of a computing device. At least one of respective modules included in the server 300 may be implemented on a general-purpose computing processor, and thus include a processor 388, an input/output device I/O 382, a memory 384, and an interface 386, and a bus 385. The processor 388, the input/output device 382, the memory 384, and/or the interface 386 may be coupled to each other through the bus 385. The bus 385 may correspond to a path for moving data.

In detail, the processor 388 may include at least one of a central processing unit (CPU), a micro processor unit (MPU), a micro controller unit (MCU), a graphic processing unit (GPU), a microprocessor, a digital signal processor, a microcontroller, an application processor (AP), and a similar logic element that may perform a similar function.

The input/output device 382 may include at least one of a keypad, a keyboard, a touch screen, and a display device. The memory 384 may store the data, a program, and/or the like.

The interface 386 may transmit the data to or receive the data from a communication network. The interface 386 may be wired or wireless. For example, the interface 386 may include an antenna or a wired or wireless transceiver. The memory 384 may be a volatile operational memory for improving an operation of the processor 388 and protecting personal information, and may further include a high-speed dynamic random access memory (DRAM) and/or static RAM (SRAM).

In addition, the memory 384 may store programming and data configurations that provide functions of some or all of the modules described herein. For example, the memory 384 may include logic to perform selected aspects of the learning method described above.

A program or an application may be loaded by a set of instructions including each operation to perform the above-described learning method stored in the memory 384, and the processor may perform each operation.

The various embodiments described hereinabove may be implemented by a computer-readable recording medium or a similar device by using, for example, software, hardware or a combination thereof.

According to a hardware implementation, the embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, the embodiments described in the specification may be implemented as a control module itself.

According to a software implementation, the embodiments such as procedures and functions, described in the specification, may be implemented by separate software modules. Each of the software modules may perform at least one function or operation described in the specification. A software code may be implemented as a software application written in a suitable programming language. The software code may be stored in a memory module and executed by the control module.

The spirit of the present disclosure has been illustratively described hereinabove. It is to be appreciated by those skilled in the art to which the present disclosure pertains that various modifications, alterations and substitutions may be made without departing from the essential features of the present disclosure.

Accordingly, the embodiments and the accompanying drawings disclosed in the present disclosure are provided not to limit the spirit of the present disclosure, but to fully describe the present disclosure, and the scope of the present disclosure is not limited to the embodiments or the accompanying drawings. The scope of the present disclosure should be interpreted by the following claims, and all the spirit equivalent to the following claims should be interpreted to fall within the scope of the present disclosure.

What is claimed is:

1. A method for generating conversation images that is performed by a computing device based on reinforcement training, the method comprising:
recognizing an object in an input image;
extracting a text by comparing the first emotion combination information for each object of the recognized object with the second emotion combination information in a unit of a sentence in a matching candidate text;
generating a conversation image including the first emotion combination information by mapping at least a part of image of the object with the extracted text; and
receiving emotion combination change information of the first emotion combination information,
wherein in the extracting the text, the text is re-extracted by comparing the emotion combination change information with the second emotion combination information in the unit of a sentence.

2. The method of claim 1, wherein in the generating the conversation image includes
regenerating at least a portion of a virtual facial image of the object based on the emotion combination change information, and
regenerating the conversation image including the emotion combination change information by mapping the regenerated virtual facial image with the re-extracted text.

3. The method of claim 2, wherein in the regenerating the virtual facial image in which the virtual facial image is regenerated by using a neural network symmetrical to a neural network that extracts the emotion combination information for each object of the recognized object.

4. The method of claim 3, wherein the neural network performs the reinforcement training by using a difference between emotion output by receiving the partial image and the virtual facial image.

5. The method of claim 4, wherein the neural network performs the reinforcement training by compensating for a difference between ranking of the emotion.

6. The method of claim 1, further comprising providing an interface for providing an original text including the extracted text,
wherein the interface for providing the original text classifies the original text based on a sequence and an action therein and provides a user with the classified text.

7. A computing device comprising:
a processor; and
a memory communicating with the processor,
wherein the memory stores an instruction causing the processor to perform operations,
the operations include
recognizing an object in an input image,
extracting a text by comparing the first emotion combination information for each object of the recognized object with the second emotion combination information in a unit of a sentence in a matching candidate text,
generating a conversation image including the first emotion combination information by mapping at least a part of image of the object with the extracted text, and
receiving emotion combination change information of the first emotion combination information,
wherein in the extracting the text, the text is re-extracted by comparing the emotion combination change information with the second emotion combination information in the unit of a sentence.

8. The device of claim 7, wherein in the generating the conversation image includes
regenerating at least a portion of a virtual facial image of the object based on the emotion combination change information, and
regenerating the conversation image including the emotion combination change information by mapping the regenerated virtual facial image with the re-extracted text.

9. The device of claim 8, wherein in the regenerating the virtual facial image in which the virtual facial image is regenerated by using a neural network symmetrical to a neural network that extracts the emotion combination information for each object of the recognized object.

10. The device of claim 9, wherein the neural network performs reinforcement training by using a difference between emotion output by receiving the partial image and the virtual facial image.

11. The device of claim 10, wherein the neural network performs the reinforcement training by compensating for a difference between ranking of the emotion.

12. The device of claim 7, further comprising providing an interface for providing an original text including the extracted text, and
the interface for providing an original text classifies the original text based on a sequence and an action therein and provides a user with the classified text.
